(19) United States
(12) Patent Application Publication
(10) Pub. No.: US 2023/0228968 A1
(43) Pub. Date: Jul. 20, 2023

(54) MIRROR HOLDING STRUCTURE AND HEAD-UP DISPLAY

(71) Applicant: Panasonic Intellectual Property Management Co., Ltd., Osaka (JP)

(72) Inventors: Kousuke SASAKI, Kanagawa (JP); Daiki KAWAI, Kanagawa (JP)

(73) Assignee: Panasonic Intellectual Property Management Co., Ltd., Osaka (JP)

(21) Appl. No.: 18/074,208

(22) Filed: Dec. 2, 2022

(30) Foreign Application Priority Data
Jan. 18, 2022 (JP) 2022-005994

(51) Int. Cl. G02B 7/182; G02B 27/01; B60K 35/00

(52) U.S. Cl. CPC G02B 7/182; G02B 27/0149; B60K 35/00; G02B 2027/0169; B60K 2370/1529

(57) ABSTRACT

A mirror holding structure includes a mirror holder that holds a mirror with an adhesive member having elasticity interposed therebetween. The mirror holder includes an elastic part that is in contact with the mirror and elastically deforms. A spring constant of the elastic part is greater than a spring constant of the adhesive member.

### CROSS REFERENCE TO RELATED APPLICATION

The present application is based on and claims priority of Japanese Patent Application No. 2022-005994 filed on Jan. 18, 2022.

### Field

The present disclosure relates to a mirror holding structure, and a head-up display including the mirror holding structure.

### Background

Patent Literature (PTL) 1 discloses a head-up display in which a concave mirror (mirror) that reflects display light is secured to a plate (mirror holder) with a double-sided adhesive tape (adhesive member) interposed therebetween.

### CITATION LIST

### Patent Literature

PTL 1: Japanese Unexamined Patent Application Publication No. 2021-165777

### SUMMARY

However, the head-up display according to PTL 1 can be improved upon.

In view of the above, the present disclosure provides a mirror holding structure and a head-up display which are capable of improving upon the above related art.

A mirror holding structure according to one aspect of the present disclosure is a mirror holding structure that holds a mirror. The mirror holding structure includes a mirror holder that holds the mirror with an adhesive member having elasticity interposed therebetween. The mirror holder includes an elastic part that is in contact with the mirror and elastically deforms. A spring constant of the elastic part is greater than a spring constant of the adhesive member.

A head-up display according to one aspect of the present disclosure is a head-up display that projects a virtual image on a display medium. The head-up display includes: the above-described mirror holding structure; a display that emits, toward the mirror, display light that produces the virtual image; and a casing that accommodates the mirror holding structure and the display.

A mirror holding structure and a head-up display according to the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating an example of usage of a head-up display according to an embodiment.

FIG. 2 is a diagram illustrating a display area in which an image displayed by the head-up display according to the embodiment is displayed.

FIG. 3 is a perspective view of part of the head-up display according to the embodiment.

FIG. 4 is an exploded perspective view of the head-up display illustrated in FIG. 3.

FIG. 5 is a perspective view of a mirror and a mirror holding structure according to the embodiment.

FIG. 6 is a diagram illustrating a first mirror holder according to the embodiment.

FIG. 7 is a diagram illustrating a second mirror holder according to the embodiment.

FIG. 8 is a cross sectional view of a joined structure joining the first mirror holder and the mirror according to the embodiment.

### DESCRIPTION OF EMBODIMENT

### [Underlying Knowledge Forming Basis of the Present Disclosure]

The inventors of the present disclosure have found out that the head-up display disclosed in the Background causes the following problems. For example, the use of an adhesive member such as a double-sided adhesive tape may cause positioning of a mirror to be inaccurate since a double-sided adhesive tape has a thickness variation between individual double-sided adhesive tapes. Accordingly, the present disclosure aims to improve the accuracy of the positioning of a mirror.

A mirror holding structure according to one aspect of the present disclosure is a mirror holding structure that holds a mirror. The mirror holding structure includes: a mirror holder that holds the mirror with an adhesive member having elasticity interposed therebetween. The mirror holder includes an elastic part that is in contact with the mirror and elastically deforms. A spring constant of the elastic part is greater than a spring constant of the adhesive member.

Moreover, a head-up display according to one aspect of the present disclosure is a head-up display that projects a virtual image on a display medium. The head-up display includes: the above-described mirror holding structure; a display that emits, toward the mirror, display light that produces the virtual image; and a casing that accommodates the mirror holding structure and the display.

Here, when attaching a mirror to a mirror holder during assembly, an adhesive member is pressed by the mirror, and thus is compressed. In this case, an elastic part of the mirror holder is also pressed by the mirror, and thus is elastically deformed. Although both of the adhesive member and the elastic part elastically restore when the application of pressing force stops, the elastic part has greater restoring force than the adhesive member since a spring constant of the elastic part is greater than a spring constant of the adhesive member. Specifically, the elastic part restores to the original shape, and following the restoration, the adhesive member elastically deforms such that the adhesive member expands. For this reason, the mirror is positioned relative to the restored elastic part. Since the adhesive member does not contribute to the positioning of the mirror as described above, the accuracy of the positioning of the mirror can be improved. In addition, since the elastic part elastically deforms even during assembly, the load on the mirror can be reduced, and deformation of the mirror after assembly can be prevented. The foregoing point can also improve the accuracy of the positioning of the mirror.

Moreover, the mirror holder may include at least three elastic parts.

With this, the mirror can be positioned at a more accurate position since the mirror can be positioned relative to at least three elastic parts.

In addition, the at least three elastic parts need not be disposed on the same straight line.

With this, the mirror can be two-dimensionally supported by these elastic parts since the at least three elastic parts are not disposed on the same straight line. Therefore, it is possible to improve the stability of the mirror after the mirror is supported.

Moreover, the adhesive member may be disposed between at least two elastic parts among the at least three elastic parts.

With this, the mirror can be positioned relative to at least two points between which the adhesive member is interposed, since the adhesive member is disposed between the two elastic parts. Accordingly, restoring force of the adhesive member is unlikely to act on the mirror, and thus the accuracy of the positioning can be further improved.

In addition, the elastic part may include a protrusion that protrudes toward the mirror and contacts the mirror.

With this, the protrusion of the elastic part concentratedly receives compressive force from the mirror during assembly since the protrusion protruding toward the mirror is in contact with the mirror. Therefore, elastic deformation of the elastic part can be smoothly performed.

Moreover, the mirror holder may be consisted of a first mirror holder that holds a first end portion of the mirror and a second mirror holder that holds a second end portion of the mirror.

With this, holding performance for the mirror can be improved, since the mirror is held by the first mirror holder and the second mirror holder. In addition, when the elastic part is provided for each of the first mirror holder and the second mirror holder, the positioning based on the elastic part can be carried out at both end portions of the mirror. Therefore, it is possible to further improve the accuracy of the positioning of the mirror.

Moreover, one of the first mirror holder and the second mirror holder may be connected with a driving source that drives the one of the first mirror holder and the second mirror holder.

With this, compared to the case where each of the first mirror holder and the second mirror holder is connected with the driving source, a simple structure can be achieved since the driving source is connected to one of the first mirror holder and the second mirror holder.

In addition, the adhesive member may be a double-sided adhesive tape.

With this, the accuracy of the positioning of a mirror can be improved even if a double-sided adhesive tape that tends to have a thickness variation between double-sided adhesive tapes is used as the adhesive member.

### Embodiment

Hereinafter, embodiments will be described in detail with reference to the drawings. Note that the embodiments described below each show a specific example of the present disclosure. The numerical values, shapes, materials, structural elements, the arrangement and connection of the structural elements, steps, and orders of the steps, etc. presented in the embodiments below are mere examples and are not intended to limit the present disclosure. Furthermore, among the structural elements in the embodiments below, those not recited in any one of the independent claims representing the most generic concepts will be described as optional structural elements.

### [1. Example of Usage of Head-Up Display]

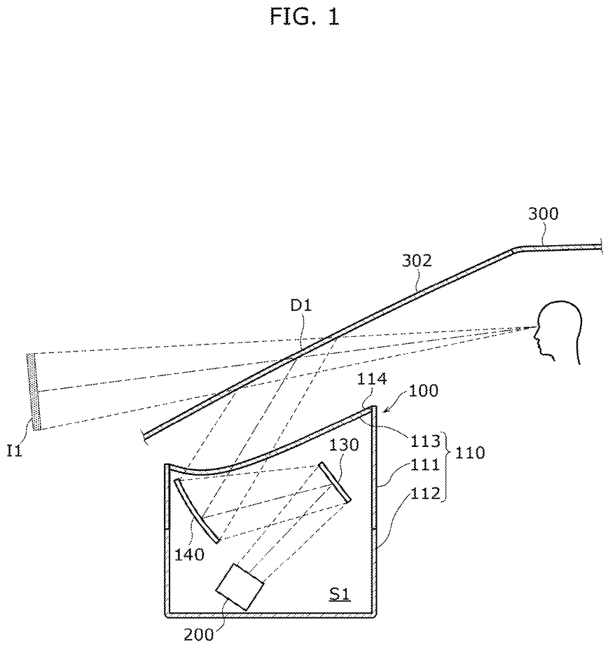

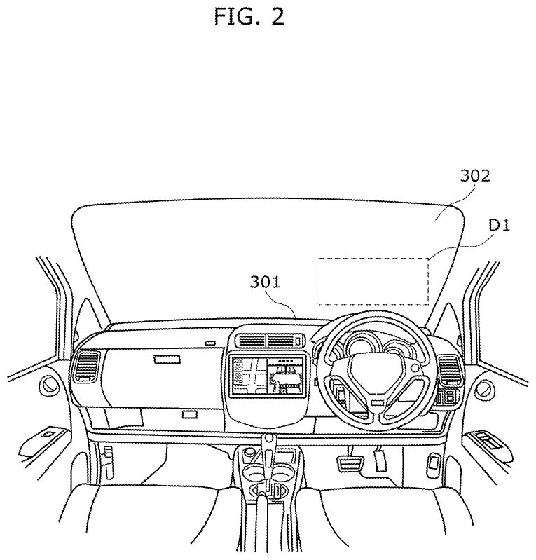

Firstly, an example of usage and a schematic configuration of head-up display 100 according to an embodiment will be described with reference to FIG. 1 and FIG. 2. FIG. 1 is a diagram illustrating an example of usage of head-up display 100 according to the embodiment. FIG. 2 is a diagram illustrating a display area in which an image displayed by head-up display 100 according to the embodiment is displayed.

Head-up display 100 according to the embodiment is configured as an in-vehicle head-up display (HUD), and is provided in the vicinity of the top surface of dashboard 301 of vehicle 300.

This head-up display 100 projects light on area D1 of windshield (front glass) 302 that is a display medium. The projected light reflects off windshield 302. This reflected light travels toward the eyes of a driver who is a user of head-up display 100 and who sits on the driver's seat. The driver perceives the reflected light that has entered the eyes as virtual image I1 shown on the opposite side of windshield 302 (outside the vehicle) with actual objects that can be seen through windshield 302 as the background. In this embodiment, the above-described series of events will be represented as head-up display 100 displaying virtual image I1 using windshield 302.

FIG. 2 is a diagram illustrating one example of D1 that is an area on which light is projected by head-up display 100 according to the embodiment.

As illustrated in FIG. 2, head-up display 100 provided on dashboard 301 projects light on area D1 (the area enclosed by a dashed line in the drawing) of windshield 302 which is located on the lower side of the driver's seat side, for example. With this, virtual image I1. (see FIG. 1) that appears to be shown on the opposite side of windshield 302 (outside the vehicle) from the view of the driver sitting on the driver's seat is displayed.

### [2. Configuration of Head-Up Display]

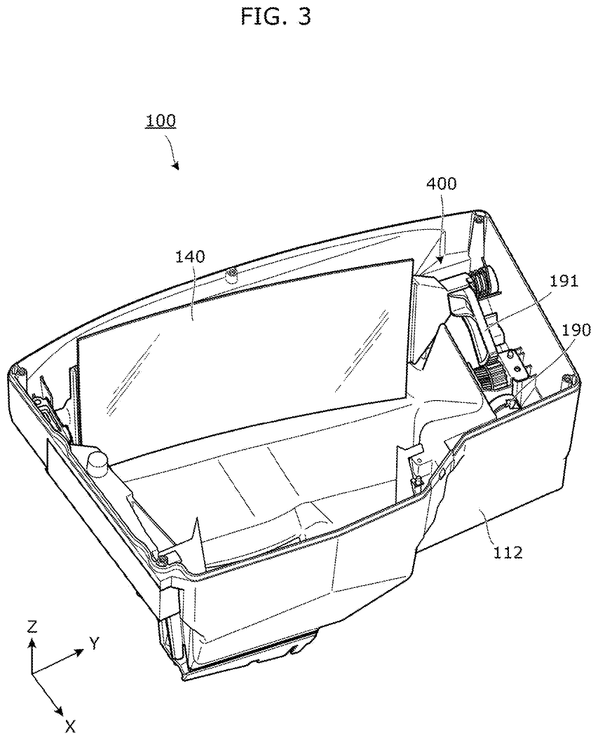

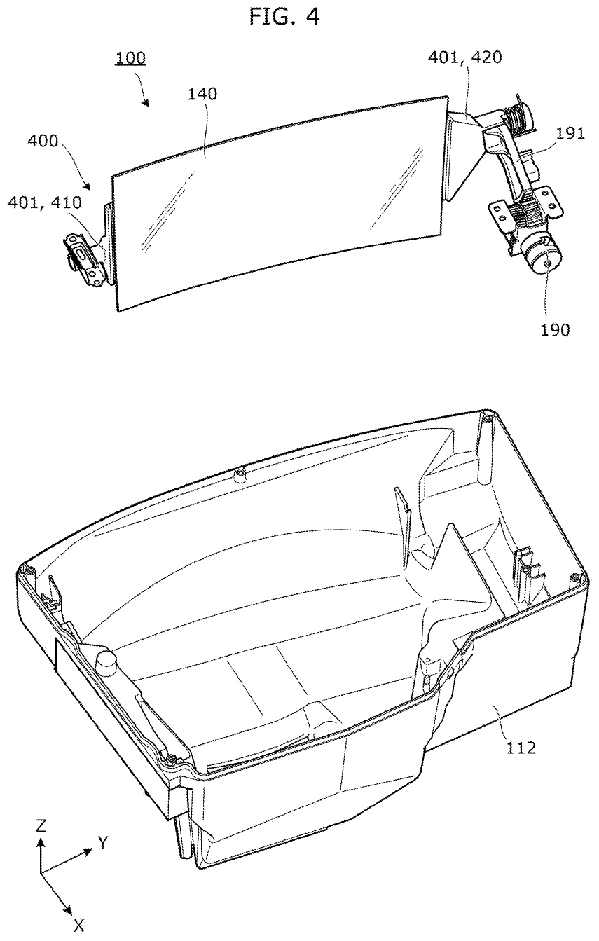

Next, a configuration of head-up display 100 will be described with reference to FIG. 1, FIG. 3, and FIG. 4. FIG. 3 is a perspective view of part of head-up display 100 according to the embodiment. FIG. 4 is an exploded perspective view of head-up display 100 illustrated in FIG. 3. In FIG. 3 and FIG. 4, a casing upper portion of casing 110 and mirror 130 are excluded from the illustrations.

Note that from FIG. 3 on down, the Z axis direction represents the vertical direction, the X axis direction represents the traveling direction of a vehicle and a direction perpendicular to the Z axis direction, and the Y axis direction represents a direction perpendicular to the Z axis direction and the X axis direction (the left-right direction of the vehicle).

As illustrated in FIG. 1, head-up display 100 includes casing 110, mirror 130, mirror 140, and liquid crystal module 200.

Casing 110 includes: casing upper portion 111 in which opening 114 is formed, and which constitutes the upper portion of a box body that is in a substantially parallelepiped shape elongated in the Y axis direction; casing lower portion 112 that constitutes the lower portion of the box body; and light transmissive cover 113 that seals opening 114 in casing upper portion 111. Casing upper portion 111 and casing lower portion 112 together create space S1 of casing 110. Casing 110 accommodates mirror 130, mirror 140, and liquid crystal module 200. Casing 110 includes, for example, resin, but may include metal.

Liquid crystal module 200 is one example of a display that irradiates a liquid crystal panel with light from a light source to irradiate mirrors 130 and 140 with display light that produces a virtual image. Note that although the whole liquid crystal module 200 is accommodated in casing 110 in this embodiment, only part of liquid crystal module 200 may be accommodated in casing 110 or liquid crystal module 200 may be disposed outside casing 110.

Mirror 130 is a mirror that reflects an image projected by liquid crystal module 200. Mirror 140 further reflects the image reflected by mirror 130 to project, through opening 114, the reflected image outside head-up display 100. Specifically, the image reflected by mirror 140 is projected on windshield 302. Mirror 130 and mirror 140 are quadrilateral plate-like members that are elongated in the Y axis direction in this embodiment. Mirrors 130 and 140 include, for example, glass, resin, or metal.

As illustrated in FIG. 3 and FIG. 4, head-up display 100 includes mirror holding structure 400 for casing 110 to hold mirror 140, and driving source 190.

Driving source 190 generates power that rotates mirror 140. Specifically, driving source 190 is a motor that applies, to mirror 140, power for changing an angle of mirror 140. The rotational axis of driving source 190 is connected to a part of mirror holding structure 400 via linkage 191. Power generated by driving source 190 is transferred to mirror holding structure 400 via linkage 191 to change an angle of mirror 140. This embodiment exemplifies the case where linkage 191 includes a link member and a gear, but linkage 191 may include a belt. Moreover, driving source 190 and mirror 140 may be directly connected with each other, not via a linkage.

### [3. Mirror Holding Structure]

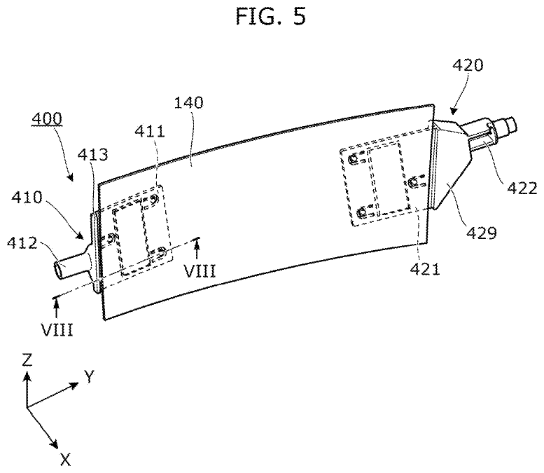

Next, mirror holding structure 400 will be described. FIG. 5 is a perspective view of mirror 140 and mirror holding structure 400 according to the embodiment. As illustrated in FIG. 5, mirror 140 is elongated in the Y axis direction, and is formed in a curved plate-like shape smoothly recessed in the negative direction of the X axis. Mirror 140 has the reflective surface in the positive direction of the X axis, and the back surface in the negative direction of the X axis.

Mirror holding structure 400 includes mirror holder 401 that rotatably hold the above-described mirror 140. Specifically, mirror holder 401 consists of first mirror holder 410 and second mirror holder 420 that hold both end portions of mirror 140 in the Y axis direction. First mirror holder 410 holds one end portion (first end portion) of mirror 140 in the negative direction of the Y axis, and second mirror holder 420 holds the other end portion (second end portion) of mirror 140 in the positive direction of the Y axis.

First mirror holder 410 includes first main body part 411 that holds the first end portion of mirror 140, and first axis part 412 that protrudes further in the negative direction of the Y axis than first main body part 411. Second mirror holder 420 includes second main body part 421 that holds the second end portion of mirror 140, and second axis part 422 that protrudes further in the positive direction of the Y axis than second main body part 421. First axis part 412 and second axis part 422 are rotatably supported by casing lower portion 112. Moreover, second axis part 422 is connected to linkage 191. With this, power from driving source 190 is transferred to second axis part 422 via linkage 191 to rotate second mirror holder 420. With this rotation, mirror 140 and first mirror holder 410 also rotate.

First mirror holder 410 and second mirror holder 420 will be described in detail.

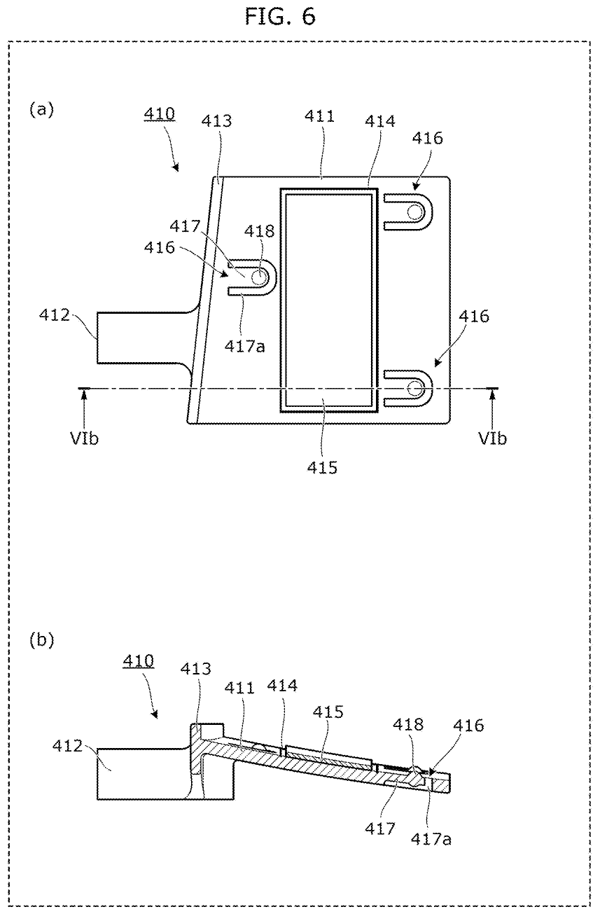

Firstly, first mirror holder 410 will be described in detail with reference to FIG. 6. FIG. 6 is a diagram illustrating first mirror holder 410 according to the embodiment. Specifically, (a) in FIG. 6 is a front view of first mirror holder 410, and (b) in FIG. 6 is a cross sectional view of first mirror holder 410 taken along line VIb-VIb in (a) in FIG. 6.

As illustrated in FIG. 6, first main body part 411 of first mirror holder 410 is a plate part formed in a trapezoid shape. First main body part 411 is disposed on the back surface side of the first end portion of mirror 140, and is attached to the back surface of the first end portion. For this reason, first main body part 411 is formed in a curved plate-like shape that corresponds with a curved surface shape of the first end portion of mirror 140. First main body part 411 includes first axis part 412 that protrudes from the first end portion. First main body part 411 is provided with wall part 413 on the first end portion which contacts one edge (first edge) of mirror 140 for positioning of the first edge.

First main body part 411 has a principal surface on the mirror 140 side, and frame 414 in the shape of a quadrilateral is formed in the middle portion of the principal surface. In first main body part 411, a surface inside frame 414 and a surface outside frame 414 are disposed on the same curved surface. In other words, the surface inside frame 414 and the surface outside frame 414 have no level difference therebetween. Adhesive member 415 is disposed inside frame 414. With this frame 414, it is possible to dispose adhesive member 415 at an accurate position. Adhesive member 415 is, for example, a double-sided adhesive tape having elasticity, and is adhered to the back surface of the first end portion of mirror 140.

First main body part 411 includes a plurality of (three in this embodiment) elastic parts 416. The plurality of elastic parts 416 are not disposed on the same straight line in the front view. Specifically, two elastic parts 416 are disposed closer to the distal end portion of first main body part 411 than frame 414 is, and are aligned along a long side of frame 414. Moreover, one remained elastic part 416 is disposed closer to the proximal end portion (the first axis part 412 side) of first main body part 411 than frame 414 is. This one elastic part 416 is disposed between the other two elastic parts 416.

Each elastic part 416 includes elastic piece 417 extending toward the distal end portion side of first main body part 411, and notch 417a that is cut out in the U shape around elastic piece 417. Elastic pieces 417 are each formed in the shape of a cantilever. When elastic pieces 417 are under no load, namely, not in an elastic deformation state, the principal surfaces of elastic pieces 417 on the mirror 140 side are disposed on the same curved surface as the principal surface of first main body part 411 on the mirror 140 side. At the distal end portion of each elastic piece 417, protrusion 418 that protrudes toward the mirror 140 side and contacts mirror 140 is formed. When mirror 140 presses protrusions 418 during assembly, elastic pieces 417 of elastic parts 416 are made to elastically deform.

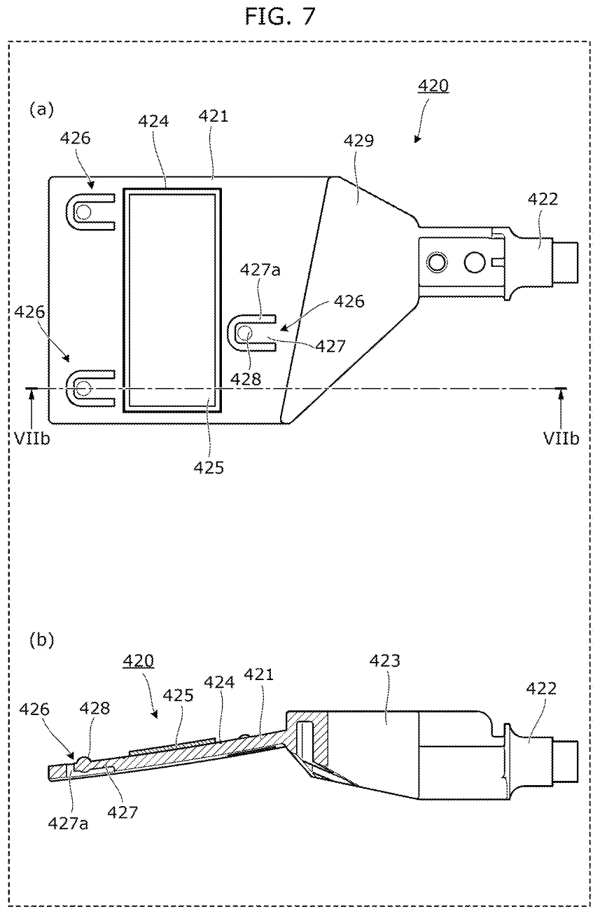

Next, second mirror holder 420 will be described in detail with reference to FIG. 7. FIG. 7 is a diagram illustrating second mirror holder 420 according to the embodiment. Specifically, (a) in FIG. 7 is a front view of second mirror holder 420, and (b) in FIG. 7 is a cross sectional view of second mirror holder 420 taken along line VIIb-VIIb in (a) in FIG. 7.

As illustrated in FIG. 7, second main body part 421 of second mirror holder 420 is a plate part formed in a trapezoid shape. Second main body part 421 is disposed on the back surface side of the second end portion of mirror 140, and is attached to the back surface of the second end portion. For this reason, second main body part 421 is formed in a curved plate-like shape that corresponds with a curved surface shape of the second end portion of mirror 140.

Intermediate part 429 is provided between second main body part 421 and second axis part 422. Intermediate part 429 has a side wall surface on the second main body part 421 side which contacts the other edge (second edge) of mirror 140 and positions the second edge.

Second main body part 421 has a principal surface on the mirror 140 side, and frame 424 in the shape of a quadrilateral is formed in the middle portion of the principal surface. In second main body part 421, a surface inside frame 424 and a surface outside frame 424 are disposed on the same curved surface. In other words, the surface inside frame 424 and the surface outside frame 424 have no level difference therebetween. Adhesive member 425 is disposed inside frame 424. With this frame 424, it is possible to dispose adhesive member 425 at an accurate position. Adhesive member 425 is, for example, a double-sided adhesive tape having elasticity, and is adhered to the back surface of the second end portion of mirror 140.

Second main body part 421 includes a plurality of (three in this embodiment) elastic parts 426. The plurality of elastic parts 426 are not disposed on the same straight line in the front view. Specifically, two elastic parts 426 are disposed closer to the distal end portion of second main body part 421 than frame 424 is, and are aligned along a long side of frame 424. Moreover, one remained elastic part 426 is disposed closer to the proximal end portion (the second axis part 422 side) of second main body part 421 than frame 424 is. This one elastic part 426 is disposed between the other two elastic parts 426.

Each elastic part 426 includes elastic piece 427 extending toward the distal end portion side of second main body part 421, and notch 427a that is cut out in the U shape around elastic piece 427. Elastic pieces 427 are each formed in the shape of a cantilever. When elastic pieces 427 are under no load, namely, not in an elastic deformation state, the principal surfaces of elastic pieces 427 on the mirror 140 side are disposed on the same curved surface as the principal surface of second main body part 421 on the mirror 140 side. At the distal end portion of each elastic piece 427, protrusion 428 that protrudes toward the mirror 140 side and contacts mirror 140 is formed. When mirror 140 presses protrusions 428 during assembly, elastic pieces 427 of elastic parts 426 are made to elastically deform.

Hereinafter, a joined structure joining mirror holder 401 and mirror 140 will be described in detail. Here, first mirror holder 410 is used as an example for the description. Since the joined structure for second mirror holder 420 is basically the same, the description of the joined structure for second mirror holder 420 is omitted.

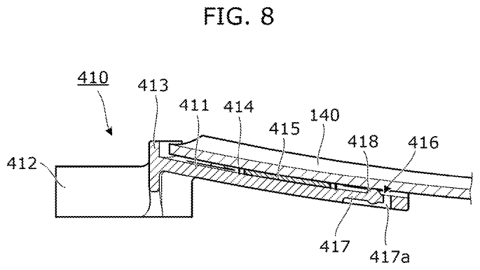

FIG. 8 is a cross sectional view of a joined structure joining first mirror holder 410 and mirror 140 according to the embodiment. FIG. 8 is a cross sectional view taken along line VIII-VIII in FIG. 5. FIG. 8 corresponds with (b) in FIG. 6.

As illustrated in FIG. 8, adhesive member 415 is interposed between first main body part 411 of first mirror holder 410 and mirror 140. This adhesive member 415 joins first main body part 411 and mirror 140 together. Here, in a state in which mirror 140 is not joined to adhesive member 415, the thickness of adhesive member 415 is less than a protruded amount of each protrusion 418 of first mirror holder 410. The protruded amount of each protrusion 418 is a distance from the principal surface of elastic piece 417 to the top of protrusion 418. Moreover, a spring constant of each elastic part 416 is set greater than a spring constant of adhesive member 415.

Furthermore, when mirror 140 is attached to first mirror holder 410, adhesive member 415 is pressed by mirror 140, and thus is compressed. In this case, elastic parts 416 of first mirror holder 410 are also pressed by mirror 140, and thus are elastically deformed. Although adhesive member 415 and elastic parts 416 elastically restore when the application of pressing force stops, elastic parts 416 have greater restoring force than adhesive member 415 since the spring constant of elastic parts 416 is greater than the spring constant of adhesive member 415. Specifically, each elastic part 416 restores to the original shape, and following the restoration, adhesive member 415 elastically deforms such that adhesive member 415 expands. For this reason, mirror 140 is positioned relative to the restored elastic parts 416.

### [4. Advantageous Effects, Etc.]

As has been described above, the mirror holding structure according to the embodiment is mirror holding structure 400 that holds mirror 140. Mirror holding structure 400 includes mirror holder 401 that holds mirror 140 with adhesive members 415 and 425 having elasticity interposed therebetween. Mirror holder 401 includes elastic parts 416 and 426 that are in contact with mirror 140 and elastically deform. The spring constant of elastic parts 416 and 426 is greater than the spring constant of adhesive members 415 and 425.

Moreover, the head-up display according to the embodiment is head-up display 100 that projects a virtual image on a display medium (windshield 302). Head-up display 100 includes: mirror holding structure 400; display (liquid crystal module 200) that emits, toward mirror 140, display light that produces the virtual image; and casing 110 that accommodates mirror holding structure 400 and the display.

When mirror 140 is attached to mirror holder 401 during assembly, adhesive members 415 and 425 are pressed by mirror 140, and thus are compressed. In this case, elastic parts 416 and 426 of mirror holder 401 are also pressed by mirror 140, and thus are elastically deformed. Although adhesive members 415 and 425 and elastic parts 416 and 426 elastically restore when the application of pressing force stops, elastic parts 416 and 426 have greater restoring force than adhesive members 415 and 425 since the spring constant of elastic parts 416 and 426 is greater than the spring constant of adhesive members 415 and 425. Specifically, elastic parts 416 and 426 restore to the original shape, and following the restoration, adhesive members 415 and 425 elastically deform such that adhesive members 415 and 425 expand. For this reason, mirror 140 is positioned relative to the restored elastic parts 416 and 426. Since adhesive members 415 and 425 do not contribute to the positioning of mirror 140 as described above, the accuracy of the positioning of a mirror can be improved. In addition, since elastic parts 416 and 426 elastically deform even during assembly, the load on mirror 140 can be reduced, and deformation of mirror 140 after assembly can be prevented. The foregoing point can also improve the accuracy of positioning of mirror 140.

Moreover, mirror holder 401 includes at least three elastic parts 416 and at least three elastic parts 426.

With this, mirror 140 can be positioned at a more accurate position since mirror 140 can be positioned relative to at least three elastic parts 416 and at least three elastic parts 426.

In addition, the at least three elastic parts 416 and the at least three elastic parts 426 are not disposed on the same respective straight lines.

With this, mirror 140 can be two-dimensionally supported by elastic parts 416 and 426 since the at least three elastic parts 416 and the at least three elastic parts 426 are not disposed on the same respective straight lines. Therefore, it is possible to improve the stability of mirror 140 after being two-dimensionally supported.

Moreover, adhesive member 415 and adhesive member 425 are disposed between at least two elastic parts 416 and between at least two elastic parts 426, respectively.

With this, mirror 140 can be positioned relative to at least two points between which adhesive member 415 is sandwiched and at least two points between which adhesive member 425 is sandwiched, since adhesive member 415 and adhesive member 425 are disposed between the two elastic parts 416 and between the two elastic parts 426, respectively. Accordingly, restoring force of adhesive members 415 and 425 is unlikely to act on mirror 140, and thus the accuracy of the positioning can be further improved.

In addition, elastic parts 416 and elastic parts 426 respectively include protrusions 418 and protrusions 428 that protrude toward mirror 140 and contacts mirror 140.

With this, protrusions 418 and 428 of respective elastic parts 416 and 426 concentratedly receive compressive force from mirror 140 during assembly since protrusions 418 and 428 protruding toward mirror 140 are in contact with mirror 140. Therefore, elastic deformation of elastic parts 416 and 426 can be smoothly performed.

Moreover, mirror holder 401 consists of first mirror holder 410 that holds a first end portion of mirror 140 and second mirror holder 420 that holds a second end portion of mirror 140.

With this, holding performance for mirror 140 can be improved, since mirror 140 is held by first mirror holder 410 and second mirror holder 420. In addition, when elastic parts 416 and elastic parts 426 are provided for first mirror holder 410 and second mirror holder 420, respectively, the positioning based on elastic parts 416 and elastic parts 426 can be carried out at both end portions of mirror 140. Therefore, it is possible to further improve the accuracy of the positioning of a mirror.

In addition, one of first mirror holder 410 and second mirror holder 420 is connected with driving source 190 that drives the one of first mirror holder 410 and second mirror holder 420.

With this, compared to the case where each of first mirror holder 410 and second mirror holder 420 is connected with driving source 190, a simple structure can be achieved since driving source 190 is connected to one of first mirror holder 410 and second mirror holder 420.

Moreover, adhesive members 415 and 425 each are a double-sided adhesive tape. With this, the accuracy of positioning of mirror 140 can be improved even if a double-sided adhesive tape that tends to have a thickness variation between double-sided adhesive tapes is used for each of adhesive members 415 and 425.

### [5. Other Embodiments]

Hereinbefore, the mirror holding structure and the head-up display according to the present disclosure have been described based on the embodiments, but the present disclosure is not limited to these embodiments. The scope of the one or more aspects of the present disclosure may encompass embodiments as a result of making, to the embodiments, various modifications that may be conceived by those skilled in the art and combining structural elements in different embodiments, as long as the resultant embodiments do not depart from the scope of the present disclosure.

For example, the above-described embodiments have exemplified each of adhesive members 415 and 425 as a double-sided adhesive tape, but each of adhesive members 415 and 425 may be an adhesive.

Moreover, the above-described embodiments have exemplified the case where mirror holder 401 consists of individual mirror holders that are first mirror holder 410 and second mirror holder 420, but a first mirror holder and a second mirror holder may be integrally formed.

In addition, the above-described embodiments have exemplified the case where first mirror holder 410 and second mirror holder 420 include three elastic parts 416 and three elastic parts 426, respectively, but any number of elastic parts may be provided. The number of elastic parts to be provided may be different between first mirror holder 410 and second mirror holder 420.

Moreover, the above-described embodiments have exemplified a motor as driving source 190, but a driving source may be other than a motor as long as a structural element can generate power for rotating mirror 140. A solenoid exemplifies the driving source other than a motor.

In addition, the above-described embodiments have exemplified the case where the thickness of adhesive member 415 is less than a protruded amount of each protrusion 418 of first mirror holder 410 in a state in which mirror 140 is not joined to adhesive member 415. However, the thickness of an adhesive member may be greater than or equal to a protrusion. Particularly, an adhesive member is kept compressed when an elastic part restores to the original shape in the case where the thickness of the adhesive member is greater than a protruded amount of a protrusion, but a mirror is positioned based on an elastic part in this case also.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims is incorporated herein by reference in their entirety: Japanese Patent Application No. 2022-005994 filed on Jan. 18, 2022.

### INDUSTRIAL APPLICABILITY

The present disclosure is useful as a mirror holding structure for holding a mirror included in a head-up display.

1. A mirror holding structure that holds a mirror, the mirror holding structure comprising:
a mirror holder that holds the mirror with an adhesive member having elasticity interposed therebetween, wherein
the mirror holder includes an elastic part that is in contact with the mirror and elastically deforms, and
a spring constant of the elastic part is greater than a spring constant of the adhesive member.

2. The mirror holding structure according to claim 1, wherein
the mirror holder includes at least three elastic parts, the at least three elastic parts each being the elastic part.

3. The mirror holding structure according to claim 2, wherein
the at least three elastic parts are not disposed on a same straight line.

4. The mirror holding structure according to claim 2, wherein
the adhesive member is disposed between at least two elastic parts among the at least three elastic parts.

5. The mirror holding structure according to claim 1, wherein
the elastic part includes a protrusion that protrudes toward the mirror and contacts the mirror.

6. The mirror holding structure according to claim 1, wherein
the mirror holder comprises a first mirror holder that holds a first end portion of the mirror and a second mirror holder that holds a second end portion of the mirror.

7. The mirror holding structure according to claim 6, wherein
one of the first mirror holder and the second mirror holder is connected with a driving source that drives the one of the first mirror holder and the second mirror holder.

8. The mirror holding structure according to claim 6, wherein
the mirror is elongated in an alignment direction in which the first mirror holder and the second mirror holder are aligned, and is formed in a curved plate-like shape recessed at a middle portion of the mirror in the alignment direction.

9. The mirror holding structure according to claim 8, wherein
the first mirror holder includes a first main body part that is formed in a curved plate-like shape corresponding with a curved surface shape of the first end portion of the mirror, and
the second mirror holder includes a second main body part that is formed in a curved plate-like shape corresponding with a curved surface shape of the second end portion of the mirror.

10. The mirror holding structure according to claim 1, wherein
the adhesive member is a double-sided adhesive tape.

11. A head-up display that projects a virtual image on a display medium, the head-up display comprising:
the mirror holding structure according to claim 1;
a display that emits, toward the mirror, display light that produces the virtual image; and
a casing that accommodates the mirror holding structure and the display.

12. A mirror holding structure that holds a mirror, the mirror holding structure comprising:
a mirror holder that holds the mirror with an adhesive member having elasticity interposed therebetween, wherein
the mirror holder includes an elastic part that is in contact with the mirror and elastically deforms, and
in a state in which application of pressing force that presses the mirror toward the mirror holder is stopped, the elastic part is restored to an original shape, and the adhesive member is elastically deformed such that the adhesive member expands.

13. A head-up display that projects a virtual image on a display medium, the head-up display comprising:
a mirror holding structure that holds a mirror;
a display that emits, toward the mirror, display light that produces the virtual image; and
a casing that accommodates the mirror holding structure and the display, wherein
the mirror holding structure includes a mirror holder that holds the mirror with an adhesive member having elasticity interposed therebetween,
the mirror holder includes an elastic part that is in contact with the mirror and elastically deforms, and
a spring constant of the elastic part is greater than a spring constant of the adhesive member.
